(19) United States
(12) Patent Application Publication
(10) Pub. No.: US 2022/0234252 A1
(43) Pub. Date: Jul. 28, 2022

(54) INJECTION MOLDING MACHINES AND RELATED METHODS FOR PRODUCING PREFORMS

(71) Applicant: NIIGON MACHINES LTD., Vaughan (CA)

(72) Inventor: Roberto Sicilia, Mississauga (CA)

(21) Appl. No.: 17/721,286

(22) Filed: Apr. 14, 2022

Related U.S. Application Data
(63) Continuation of application No. PCT/CA2020/051384, filed on Oct. 16, 2020.
(60) Provisional application No. 62/915,965, filed on Oct. 16, 2019.

(51) Int. Cl. B29B 11/08; B29B 11/14

(52) U.S. Cl. CPC B29B 11/08; B29B 11/14; B29K 2995/0067; B29C 2949/079; B29C 2949/3034

(57) ABSTRACT

A method for injection molding a preform includes: a) loading a barrier membrane into a first mold cavity; b) injecting melt into the first mold cavity to undermold the barrier membrane and form a preform inner layer on an inside of the barrier membrane; c) moving the preform inner layer and the barrier membrane from the first mold cavity into a second mold cavity; and d) injecting melt into the second mold cavity to overmold the barrier membrane and form a preform outer layer on an outside of the barrier membrane. Preforms formed by the method and an injection molding machine to carry out the method are also disclosed.

This application is a continuation of International Application Serial No. PCT/CA2020/051384, filed Oct. 16, 2020, which claims the benefit of Provisional Application Ser. No. 62/915,965, filed Oct. 16, 2019, the entire contents of which are hereby incorporated by reference.

### FIELD

The specification relates generally to injection molding, and more specifically to injection molded preforms, and injection molding machines and related methods for producing preforms.

### BACKGROUND

U.S. Pat. No. 5,759,654 (Cahill) discloses an injection molding process for making a multiple layer, plastic structure. A plastic sleeve is placed and then enclosed in a mold cavity. A flowing heated plastic is conducted into the mold cavity, radially inside the sleeve, and forced radially outward against the sleeve. The flowing plastic forces the sleeve outward and forms, with the sleeve, an integrally bonded laminated structure. The mold is opened and the plastic structure is removed, and this structure may then be reformed to form a container particularly suitable for containing beverages, foods, cosmetics, pharmaceuticals and chemicals.

U.S. Pat. No. 4,797,244 (Sauer) discloses a multiwalled plastic container having a barrier liner and an outer wall providing structural support for the liner.

U.S. Pat. No. 5,851,471 (Schloss et al.) discloses a method of injection molding a multi-layer preform from a combination of virgin and recycled plastic such as PET so that the resultant blow-molded bottle has a reduced tendency for bottom failure in spite of the use of recycled plastic. A first plastic preform for providing the inner layer of the multi-layer preform is provided with spaced channels on the exterior surface of a closed end thereof extending from a central region of that end to the sidewalls. An injection mold cavity is provided with a like plurality of channels formed therein in a closed end thereof communicating with the injection gate of an injection molding apparatus. The first plastic preform is inserted into the injection mold cavity with the respective channels of the preform and the injection mold cavity substantially aligned. A second layer of plastic material is overmolded onto the first layer by injection molding in the cavity. A third layer of plastic material may be overmolded on the second layer to form a three-layer preform. Preferably the first and third layers are formed from virgin plastic and the second layer is formed from recycled plastic.

### SUMMARY

The following summary is intended to introduce the reader to various aspects of the applicant's teaching, but not to define any invention. In general, disclosed herein are one or more methods or apparatuses related to injection molding.

According to some aspects, a method for injection molding a preform includes: (a) loading a barrier membrane into a first mold cavity; (b) injecting melt into the first mold cavity to undermold the barrier membrane and form a preform inner layer on an inside of the barrier membrane; (c) moving the preform inner layer and the barrier membrane from the first mold cavity into a second mold cavity; and (d) injecting melt into the second mold cavity to overmold the barrier membrane and form a preform outer layer on an outside of the barrier membrane.

In some examples, the barrier membrane is sealed between the preform inner layer and the preform outer layer. In some examples, the preform inner layer defines at least a portion of a preform interior surface of the preform, and the preform outer layer defines at least a portion of a preform exterior surface of the preform.

In some examples, the barrier membrane is formed of a generally thin, film-like article, shaped to line the first mold cavity, and impermeable to at least one of gas and light.

In some examples, step (a) includes positioning a sidewall of the barrier membrane and a base of the barrier membrane extending radially inwardly from the sidewall against a cavity inner surface of the first mold cavity, and step (b) includes injecting melt through a gate opening in the base of the barrier membrane.

In some examples, step (a) includes moving an end-of-arm tooling holding the barrier membrane from a retracted position, in which the end-of-arm tooling is clear of the first mold cavity, to an advanced position in which a loader of the end-of-arm tooling is in alignment with the first mold cavity for transferring the barrier membrane to the first mold cavity.

In some examples, during step (b), melt is injected into a first mold space between a membrane inner surface of the barrier membrane and a core outer surface of a mold core received in the first mold cavity.

In some examples, during steps (c) and (d), the preform inner layer is held on the mold core.

In some examples, step (c) includes rotating a center mold section holding the mold core from a first position in which the mold core is in alignment with the first mold cavity, to a second position in which the mold core is in alignment with the second mold cavity.

In some examples, during step (d), melt is injected into a second mold space between a membrane outer surface of the barrier membrane and a cavity inner surface of the second mold cavity.

According to some aspects, a method for injection molding a preform includes (a) loading a barrier membrane into a first mold cavity; (b) injecting melt into the first mold cavity to cover a first side of the barrier membrane with a first preform layer; (c) moving the first preform layer and the barrier membrane from the first mold cavity into a second mold cavity; and (d) injecting melt into the second mold cavity to cover a second side of the barrier membrane opposite the first side with a second preform layer.

In some examples, the barrier membrane is sealed between the first and second preform layers. In some examples, the first side of the barrier membrane corresponds to a membrane inner surface of the barrier membrane directed toward an interior of the preform, and the second side of the barrier membrane corresponds to a membrane outer surface of the barrier membrane opposite the membrane inner surface.

According to some aspects, an injection molded preform is formed according to one of the methods of the present disclosure.

According to some aspects, a preform extends along an axis between an open end and a closed end. The preform includes an preform inner layer; an preform outer layer; and an intermediate barrier membrane between the preform inner layer and the preform outer layer. The barrier membrane has a generally cylindrical membrane sidewall extending along the axis, a membrane base extending radially inwardly from the membrane sidewall at the closed end of the preform, and a gate opening in the membrane base. The gate opening is filled with material forming one of the inner preform layer and the outer preform layer. In some examples, the gate opening is coaxial with the axis. In some examples, the barrier membrane is sealed between the inner preform layer and the outer preform layer.

According to some aspects, an injection molding machine for producing preforms includes: (a) a base extending lengthwise along a horizontal machine axis; (b) a first platen supported by the base and holding a first mold section, the first mold section having a plurality of first mold cavities; (c) a second platen supported by the base and translatable relative to the first platen along the machine axis between mold-open and mold-closed positions, the second platen holding a second mold section, the second mold section having a plurality of second mold cavities; and (d) a rotary apparatus slidably supported by the base axially intermediate the first and second platens and translatable therebetween along the machine axis. The rotary apparatus holds at least one center mold section having a plurality of mold cores. When the platens are in the mold-open position, the rotary apparatus is operable to rotate the center mold section about a vertical axis among at least a first position and a second position. When the center mold section is in the first position, the mold cores are in alignment with the first mold cavities for forming a plurality of first molds when the platens are in the mold-closed position. The first molds are shaped for receiving a barrier membrane and undermolding the barrier membrane to form a preform inner layer on an inside of the barrier membrane. When the center mold section is in the second position, the mold cores are in alignment with the second mold cavities for forming a plurality of second molds when the platens are in the mold-closed position. The second molds are shaped for receiving the barrier membrane and the inner preform layer and overmolding the barrier membrane to form a preform outer layer on an outside of the barrier membrane. The machine further includes (e) a barrier membrane loading apparatus adjacent the first platen. The loading apparatus includes an end-of-arm tooling having a plurality of loaders for loading the barrier membranes into the first mold cavities. The end-of-arm tooling is moveable between a retracted position clear of the first mold cavities, and an advanced position in which the loaders are between the first and center mold sections and in alignment with the first mold cavities for transferring the barrier membranes to the first mold cavities.

In some examples, the machine further includes a first injection apparatus supported by the base for injecting melt into the first mold cavities, a second injection apparatus supported by the base for injecting melt into the second mold cavities, and a control system configured to: (i) operate the barrier membrane loading apparatus to move the end-of-arm tooling to the advanced position and load the barrier membranes into respective first mold cavities; (ii) operate the first injection apparatus to inject melt into each first mold to undermold each barrier membrane and form the preform inner layer on the inside of each barrier membrane; (c) operate the rotary apparatus to move the mold cores from the first position to the second position while the barrier membranes and corresponding preform inner layers are held on respective mold cores; and (d) operate the second injection apparatus to inject melt into each second mold to overmold each barrier membrane and form the preform outer layer on the outside of each barrier membrane.

In some examples, the rotary apparatus supports horizontally opposed first and second center mold sections and horizontally opposed third and fourth center mold sections perpendicular to the first and second center mold sections. Each center mold section is movable among at least the first and second positions.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic elevation view taken from the operator side of an example injection molding machine shown in a mold-open condition;

FIG. 2 is a schematic elevation view like that of FIG. 1, but with the machine shown in a mold-closed condition;

FIG. 3 is a schematic side view of an example molded preform formed by the machine of FIG. 1;

FIG. 3A is a cross-sectional view taken along line 3A-3A of the preform of FIG. 3;

FIG. 3B is a cross-sectional view taken along line 3B-3B of the preform of FIG. 3;

FIG. 4 is a schematic top view of a clamp portion of the machine of FIG. 1;

FIG. 5A is a schematic showing a loader of the machine of FIG. 1 holding a barrier membrane of the preform of FIG. 3 in alignment with and spaced apart from a first mold cavity of the machine of FIG. 1;

FIG. 5B is a schematic showing the loader and barrier membrane in the first mold cavity;

FIG. 5C is a schematic showing melt being injected into the first mold cavity between the barrier membrane and a mold core of the machine of FIG. 1 to form a preform inner layer;

FIG. 5D is a schematic showing the barrier membrane and the preform inner layer held on the mold core;

FIG. 5E is a schematic showing the barrier membrane and preform inner layer in a second mold cavity of the machine of FIG. 1, and melt being injected between the barrier layer and the second mold cavity to form a preform outer layer; and

FIG. 5F is a schematic showing the barrier membrane between the preform inner and outer layers.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

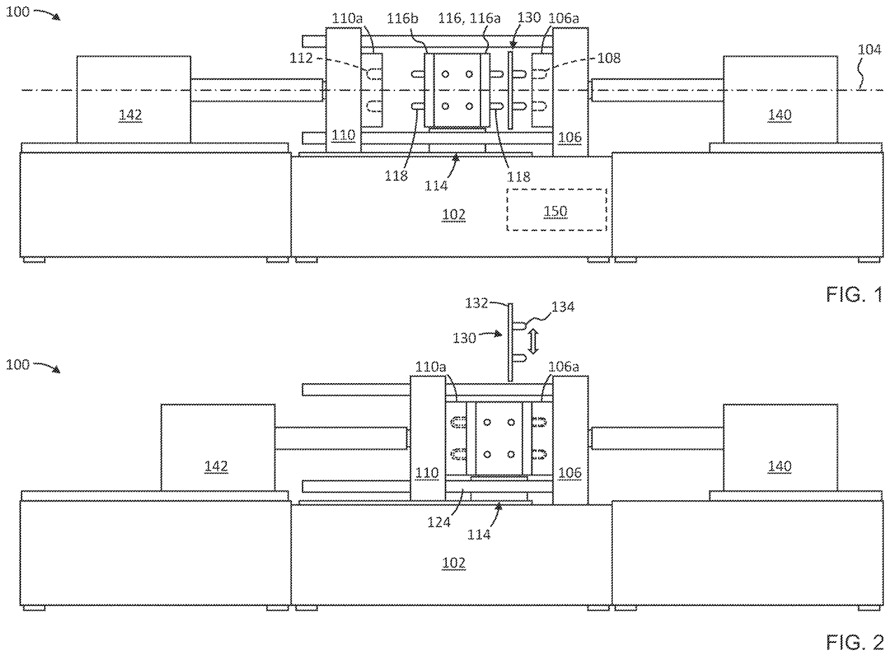

Referring to FIGS. 1 and 2, an example of an injection molding machine 100 is shown set up for producing preforms that can be used as input material for subsequent processing, for example, a blow molding operation to produce beverage (or other types of) containers.

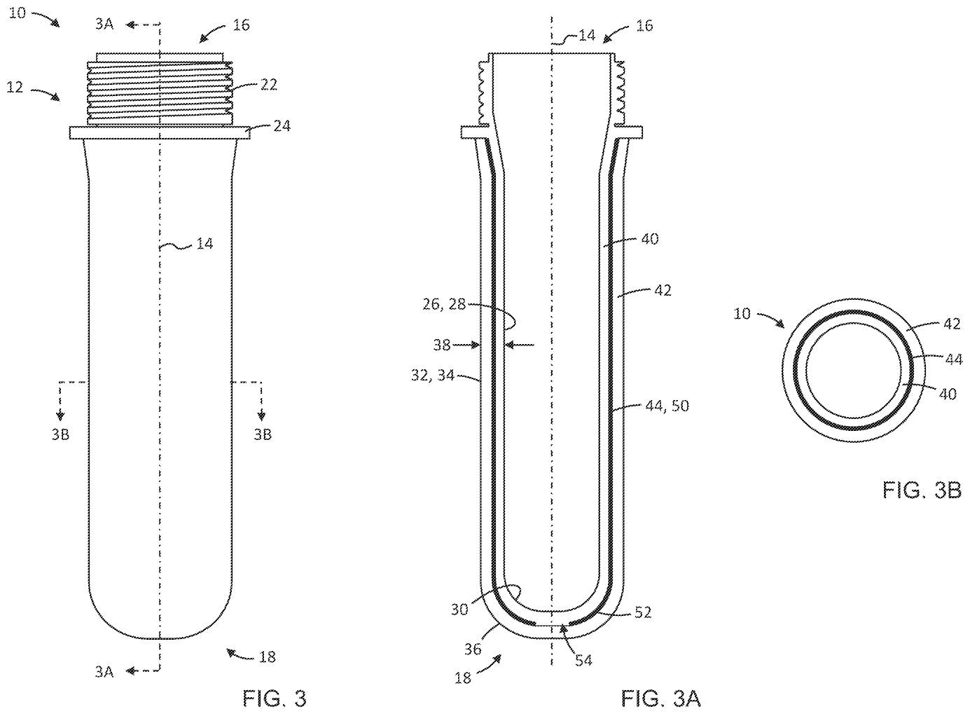

Referring to FIGS. 3-3B, schematic illustrations of an example preform 10 producible by the machine 100 are shown. In the example illustrated, the preform 10 has a generally elongate tubular body 12 extending along a preform axis 14 between an open end 16 and an opposed closed end 18. A threaded portion 22 for receiving a closure is provided adjacent the open end 16. A radially outwardly extending annular flange 24 is adjacent the threaded portion 22, with the threaded portion 22 axially intermediate the open end 16 and the flange 24. Referring to FIG. 3A, the preform 10 has an inner surface 26. In the example illustrated, the inner surface 26 includes a generally cylindrical inner side portion 28 extending along the axis 14 (between the open and closed ends 16, 18), and a generally concave inner end portion 30 extending radially inwardly from the inner side portion at the closed end 18. The preform 10 has an outer surface 32 spaced apart from the inner surface 26. The outer surface 32 includes a generally cylindrical outer side portion 34 extending along the axis 14 and a convex outer end portion 36 extending radially inwardly from the outer side portion 34 at the closed end 18. The spacing between the inner and outer surfaces 26, 32 generally defines a preform wall thickness 38.

In the example illustrated, the preform 10 is formed of an inner preform layer 40 (also referred to as a first preform layer 40), an outer preform layer 42 (also referred to as a second preform layer 42), and an intermediate barrier membrane 44 between the inner preform layer 40 and the outer preform layer 42. In the example illustrated, the inner preform layer 40 defines at least a portion of the inner surface 26 and the outer preform layer 42 defines at least a portion of the outer surface 32. In the example illustrated, the inner preform layer 40 defines the inner end portion 30 and the inner side portion 28 of the inner surface 26, and the outer preform layer 42 defines the outer end portion 36 and at least a portion of the outer side portion 34 of the outer surface 32 (up to an underside of the flange 24, in the example illustrated).

In the example illustrated, the barrier membrane 44 is formed of a generally thin, film-like article, and is impermeable to one or more of gas and light, which can help to, for example, extend shelf life of product stored in containers produced using the preform 10. As described in more detail below, the barrier membrane 44 is premanufactured, and subsequently under- and overmolded with the inner and outer preform layers 40, 42, respectively, to form the preform 10. The barrier membrane 44 can be premanufactured using, for example, a thermo-forming or injection molding process, prior to formation of the preform 10.

In the example illustrated, the barrier membrane 44 is sealed between the inner and outer preform layers 40, 42. The barrier membrane 44 has a membrane sidewall 50 extending along the axis 14 (and positioned between the inner and outer side portions 28, 34) and a membrane base 52 extending radially inwardly from the membrane sidewall 50 at the closed end 18 of the preform 10 (and positioned between the inner and outer end portions 30, 36). The membrane sidewall 50 is generally tubular in the example illustrated. In the example illustrated, the barrier membrane 44 has a gate opening 54 in the membrane base 52. As described in more detail below, the gate opening 54 can accommodate injection of melt from a mold gate through the barrier membrane 44 to form the inner preform layer 40 (or in some examples, the outer preform layer 42). When the preform 10 is formed, the gate opening 54 can be filled with material forming one of the inner preform layer 40 and the outer preform layer 42. In the example illustrated, the material forming the inner preform layer 40 fills the gate opening 54. In the example illustrated, the gate opening 54 is coaxial with the axis 14.

Referring to FIGS. 1 and 2, in the example illustrated, the machine 100 for molding the preform 10 includes a base 102 extending lengthwise along a horizontal machine axis 104. A first platen 106 is supported by the base 102 and holds a first mold section 106a having a plurality of first mold cavities 108. A second platen 110 is supported by the base 102 and holds a second mold section 110a having a plurality of second mold cavities 112. The second platen 110 is translatable relative to the first platen 106 along the machine axis 104 between a mold-open position (shown in FIG. 1) and mold-closed position (shown in FIG. 2). In the example illustrated, the second platen 110 is slidably supported by the base 102 for translating towards and away from the first platen 106, which is stationary in the example illustrated.

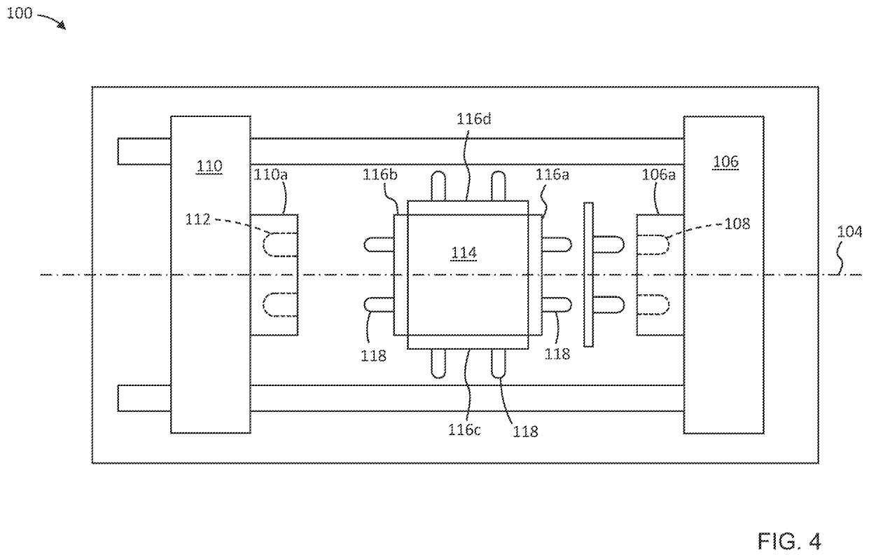

In the example illustrated, a rotary apparatus 114 is slidably supported by the base 102 axially intermediate the first and second platens 106, 110, and is translatable between the first and second platens 106, 110 along the machine axis 104. In the example illustrated, the rotary apparatus 114 holds at least one center mold section 116 having a plurality of mold cores 118. Referring to FIG. 4, in the example illustrated, the rotary apparatus 114 supports horizontally opposed first and second center mold sections 116a, 116b and horizontally opposed third and fourth center mold sections 116c, 116d perpendicular to the first and second center mold sections 116a, 116b.

When the platens 106, 110 are in the mold-open position, the rotary apparatus 114 is operable to move the center mold section 116 about a vertical axis among at least a first position and a second position. Referring to FIG. 2, when the center mold section 116 is in the first position, the mold cores 118 are in alignment with the first mold cavities 108 for forming a plurality of first molds when the platens 106, 110 are in the mold-closed position. The first molds are shaped for receiving the barrier membrane 44, and undermolding the barrier membrane 44 to form the inner preform layer 40 on an inside (also referred to as a first side) of the barrier membrane 44. In the example illustrated, the first center mold section 116a is shown in the first position.

When the center mold section 116 is in the second position, the mold cores 118 are in alignment with the second mold cavities 112 for forming a plurality of second molds when the platens 106, 110 are in the mold-closed position. The second molds are shaped for receiving the barrier membrane 44 and the inner preform layer 40 formed on the inside of the barrier membrane 44, and overmolding the barrier membrane 44 to form the outer preform layer 42 on an outside (also referred to as a second side) of the barrier membrane 44. In the example illustrated, the second center mold section 116b is shown in the second position.

Referring to FIGS. 1 and 2, in the example illustrated, the machine 100 further includes a barrier membrane loading apparatus 130 adjacent the first platen 106. Referring to FIG. 2, the loading apparatus 130 includes an end-of-arm tooling 132 having a plurality of loaders 134 for loading the barrier membranes 44 into the first mold cavities 108. The end-of-arm tooling 132 is moveable between a retracted position (shown in FIG. 2) clear of the first mold section 106a (and the first mold cavities 108), and an advanced position (shown in FIG. 1) in which the loaders 134 are between the first and center mold sections 106a, 116 and in alignment with the first mold cavities 108 for transferring the barrier membranes 44 to the first mold cavities 108. In the example illustrated, the end-of-arm tooling 130 is movable vertically between the retracted and advanced positions.

Referring to FIG. 2, a plurality of tie bars 124 extend parallel to the machine axis 104 between the first and second platens 106, 110. The second platen 110 can be releasably locked to the tie bars 124 for exerting a clamp load across the mold sections 106a, 110a, 116 when the first and second platens 106 108 are in the mold-closed position.

Referring to FIG. 1, in the example illustrated, the machine 100 further includes a first injection apparatus 140 supported by the base 102 for injecting melt into the first mold cavities 108, and a second injection apparatus 142 supported by the base 102 for injecting melt into the second mold cavities 112. In the example illustrated, the first injection apparatus 140 is supported by the base 102 behind (i.e. axially outboard of) the first platen 106 for injecting melt into the first mold cavities 108 through the first platen 106, and the second injection apparatus 142 is supported by base 102 behind (i.e. axially outboard of) the second platen 110 for injecting melt into the second mold cavities 112 through the second platen 110. The second injection apparatus 142 is translatable along the machine axis 104 to accommodate translation of the second platen 110 during movement between the mold-open and mold-closed positions.

In the example illustrated, the machine 100 further includes a control system 150 (FIG. 1) including one or more controllers configured to operate the machine components according to the processes disclosed herein to produce the preforms 10.

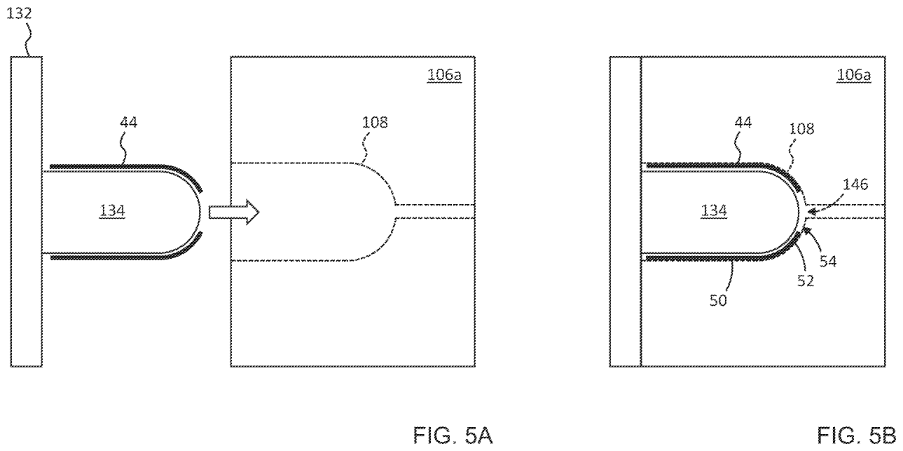

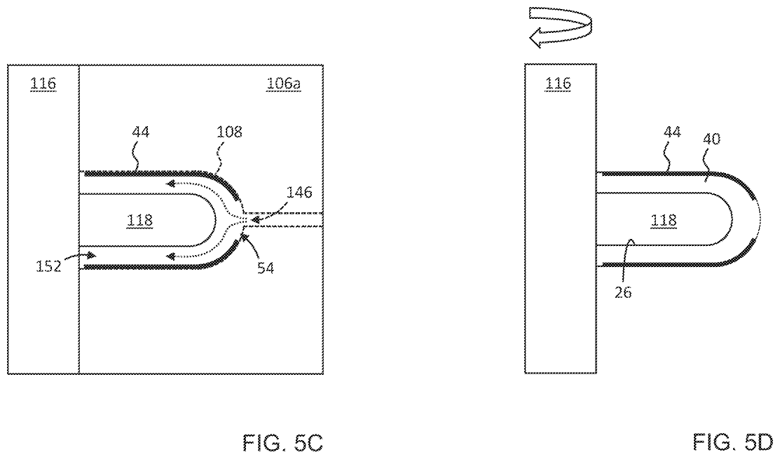

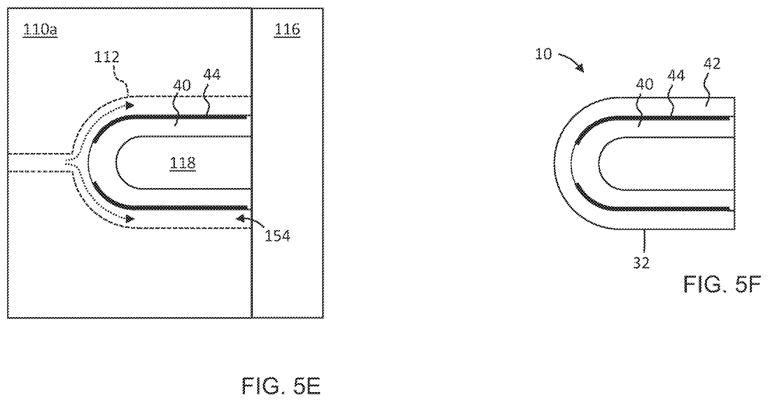

Referring to FIGS. 5A and 5B, in use, when the platens 106, 110 are in the mold-open position, the barrier membrane 44 is loaded into the first mold cavity 108. Referring to FIG. 5A, to load the barrier membrane 44, the end-of-arm tooling 132 holding the barrier membrane 44 is moved from the retracted position to the advanced position and inserted into the first mold cavity 108 for transferring the barrier membrane 44 to the first mold cavity 108. Referring to FIG. 5B, the barrier membrane 44 is shaped to line the first mold cavity 108, and when loaded, the sidewall 50 and base 52 of the barrier membrane 44 are positioned against an inner surface of the first mold cavity 108, with the gate opening 54 of the barrier membrane in alignment (and coaxial) with a gate 146 of the first mold cavity 108.

After the barrier membrane 44 is released from the loader 134 and transferred into the first mold cavity 108, the end-of-arm tooling 132 is withdrawn from the first mold cavity 108 and moved to the retracted position (clear of the mold area), and the platens 106, 110 are moved to the mold-closed position to form the first mold.

Referring to FIGS. 5C and 5D, when sufficient clamp load has been applied across the first mold, melt is injected into the first mold cavity 108 (via operation of the first injection apparatus 140) to undermold the barrier membrane 44 and form the inner preform layer 40 on the inside of the barrier membrane 44. In the example illustrated, melt is injected into the first mold cavity 108 through the gate 146 of the first mold cavity 108 and the gate opening 54 of the barrier membrane 44. In the example illustrated, melt is injected into a first mold space 152 of the first mold between the barrier membrane 44 and an outer surface of the mold core 118, which shapes at least a portion of the inner surface 26 of the preform 10.

Referring to FIGS. 5D and 5E, once injection into the first mold is complete, the clamp force is relieved, the platens 106, 110 are moved to the mold-open position, and the barrier membrane 44 and the inner preform layer 40 formed on the barrier membrane 44 are moved from the first mold cavity 108 to the second mold cavity 112. In the example illustrated, the barrier membrane 44 and inner preform layer 40 are held on the mold core 118 during movement from the first mold cavity 108 to the second mold cavity 112. In the example illustrated, moving the barrier membrane 44 and inner preform layer 40 to the second mold cavity 112 includes moving the center mold section 116 from the first position to the second position, and then moving the platens 106, 110 to the mold-closed position.

Referring to FIGS. 5E and 5F, when sufficient clamp load has been applied across the second mold, melt is injected into the second mold cavity 112 (via operation of the second injection apparatus 142) to overmold the barrier membrane 44 and form the outer preform layer 42 on the outside of the barrier membrane 44. In the example illustrated, melt is injected into a second mold space 154 between the barrier membrane 44 and an inner surface of the second mold cavity 112, which shapes at least a portion of the outer surface 32 of the preform 10. Once injection into the second mold is complete, the clamp force is relieved, the platens 106, 110 are moved to the mold-open position, and the preform 10 can be allowed to cool and/or ejected for subsequent handling and/or post-mold cooling.

1. A method for injection molding a preform, comprising:
a) loading a barrier membrane into a first mold cavity;
b) injecting melt into the first mold cavity to undermold the barrier membrane and form a preform inner layer on an inside of the barrier membrane;
c) moving the preform inner layer and the barrier membrane from the first mold cavity into a second mold cavity; and
d) injecting melt into the second mold cavity to overmold the barrier membrane and form a preform outer layer on an outside of the barrier membrane.

2. The method of claim 1, wherein the barrier membrane is sealed between the preform inner layer and the preform outer layer.

3. The method of claim 1, wherein the preform inner layer defines at least a portion of a preform interior surface of the preform, and the preform outer layer defines at least a portion of a preform exterior surface of the preform.

4. The method of claim 1, wherein the barrier membrane is formed of a generally thin, film-like article, shaped to line the first mold cavity, and impermeable to at least one of gas and light.

5. The method of claim 1, wherein step a) includes positioning a sidewall of the barrier membrane and a base of the barrier membrane extending radially inwardly from the sidewall against a cavity inner surface of the first mold cavity, and step b) includes injecting melt through a gate opening in the base of the barrier membrane.

6. The method of claim 1, wherein step a) includes moving an end-of-arm tooling holding the barrier membrane from a retracted position, in which the end-of-arm tooling is clear of the first mold cavity, to an advanced position, in which a loader of the end-of-arm tooling is in alignment with the first mold cavity for transferring the barrier membrane to the first mold cavity.

7. The method of claim 1, wherein during step b), melt is injected into a first mold space between a membrane inner surface of the barrier membrane and a core outer surface of a mold core received in the first mold cavity.

8. The method of claim 7, wherein during steps c) and d), the preform inner layer is held on the mold core.

9. The method of claim 8, wherein step c) includes rotating a center mold section holding the mold core from a first position in which the mold core is in alignment with the first mold cavity, to a second position in which the mold core is in alignment with the second mold cavity.

10. The method of claim 1, wherein during step d), melt is injected into a second mold space between a membrane outer surface of the barrier membrane and a cavity inner surface of the second mold cavity.

11. A method for injection molding a preform, comprising:
a) loading a barrier membrane into a first mold cavity;
b) injecting melt into the first mold cavity to cover a first side of the barrier membrane with a first preform layer;
c) moving the first preform layer and the barrier membrane from the first mold cavity into a second mold cavity; and
d) injecting melt into the second mold cavity to cover a second side of the barrier membrane opposite the first side with a second preform layer.

12. The method of claim 11, wherein the barrier membrane is sealed between the first and second preform layers.

13. The method of claim 11, wherein the first side of the barrier membrane defines a membrane inner surface of the barrier membrane directed toward an interior of the preform, and the second side of the barrier membrane defines a membrane outer surface of the barrier membrane opposite the membrane inner surface.

14. The method of claim 13, wherein during step b), melt is injected into a first mold space between the membrane inner surface of the barrier membrane and a core outer surface of a mold core received in the first mold cavity.

15. The method of claim 14, wherein during step d), melt is injected into a second mold space between the membrane outer surface of the barrier membrane and a cavity inner surface of the second mold cavity.

16. The method of claim 11, wherein step a) includes positioning a sidewall of the barrier membrane and a base of the barrier membrane extending radially inwardly from the sidewall against a cavity inner surface of the first mold cavity, and step b) includes injecting melt through a gate opening in the base of the barrier membrane.

17. An injection molded preform formed according to the method of claim 11.

18. An injection molded preform, comprising:
a) an open end, a closed end, and an axis extending between the open end and the closed end;
b) a preform inner layer;
c) a preform outer layer; and
d) an intermediate barrier membrane between the preform inner layer and the preform outer layer, the barrier membrane having a generally cylindrical membrane sidewall extending along the axis, a membrane base extending radially inwardly from the membrane sidewall at the closed end of the preform, and a gate opening in the membrane base, the gate opening filled with material from which at least one the preform inner layer and the preform outer layer are formed.

19. The injection molded preform of claim 18, wherein the gate opening is coaxial with the axis.

20. The injection molded preform of claim 18, wherein the barrier membrane is sealed between the preform inner layer and the preform outer layer.
